(19) United States
(12) Patent Application Publication
(10) Pub. No.: US 2013/0062178 A1
(43) Pub. Date: Mar. 14, 2013

(54) PRESSURE SWITCH

(71) Applicants: Barry Scott Mitchell, Boxford, MA (US); Mark Alan Gauthier, Georgetown, MA (US)

(72) Inventors: Barry Scott Mitchell, Boxford, MA (US); Mark Alan Gauthier, Georgetown, MA (US)

(21) Appl. No.: 13/229,485

(22) Filed: Sep. 9, 2011

(51) Int. Cl. H01H 9/00

(52) U.S. Cl. 200/505

(57) ABSTRACT

A pressure switch includes an outer contact tube, that includes first and second parallel planar contact sheets. An inner conductor is disposed between the planar contact sheets, and an insulator, which includes first and second parallel planar insulator sheets, is disposed between the inner conductor and the outer contact tube.

### BACKGROUND OF THE INVENTION

The present invention generally relates to electrical switches, and, more specifically, to pressure contact switches.

Some pressure contact switches may include a plurality of components that may require complex assembly and may experience damage from repeated use due to material from fatigue. Some other pressure contact switches become inoperable when moving portions or contacts fail due to material fatigue. Some pressure contact switches require housings or packaging components that serve only as structural support or containment for the contact switch.

As can be seen, there is a need for an improved apparatus and method that is resistant to failure due to fatigue, and that utilizes simple assembly.

### SUMMARY OF THE INVENTION

In one aspect of the present invention, a pressure switch assembly comprises an outer contact tube, wherein the outer contact tube comprises a first planar contact sheet and a second planar contact sheet, wherein the first contact sheet is parallel to the second contact sheet; an inner conductor disposed between the first contact sheet and the second contact sheet; and an insulator disposed between the outer contact tube and the inner conductor, wherein the insulator comprises a first planar insulator sheet, wherein the first insulator sheet is parallel to the first planar contact sheet, and wherein a force applied to the outer contact tube effects electrical contact between the outer contact tube and the inner conductor.

In another aspect of the present invention, a pressure switch comprises an outer contact sheet; an inner conductor; and an insulator disposed between the outer contact sheet and the inner conductor, wherein the insulator has a plurality of apertures formed therein that allow electrical communication between the outer contact sheet and the inner conductor in response to a force applied to the outer contact sheet, wherein the outer contact sheet is a conductive film.

These and other features, aspects and advantages of the present invention will become better understood with reference to the following drawings, description and claims.

### BRIEF DESCRIPTION OF THE DRAWINGS

FIG. 1 is an oblique perspective view of a pressure switch assembly according to an exemplary embodiment of the present invention;

FIG. 2 is an exploded view of the pressure switch assembly of FIG. 1; and

FIG. 3 is a cross sectional view of the pressure switch assembly of FIG. 1 taken along line 3-3.

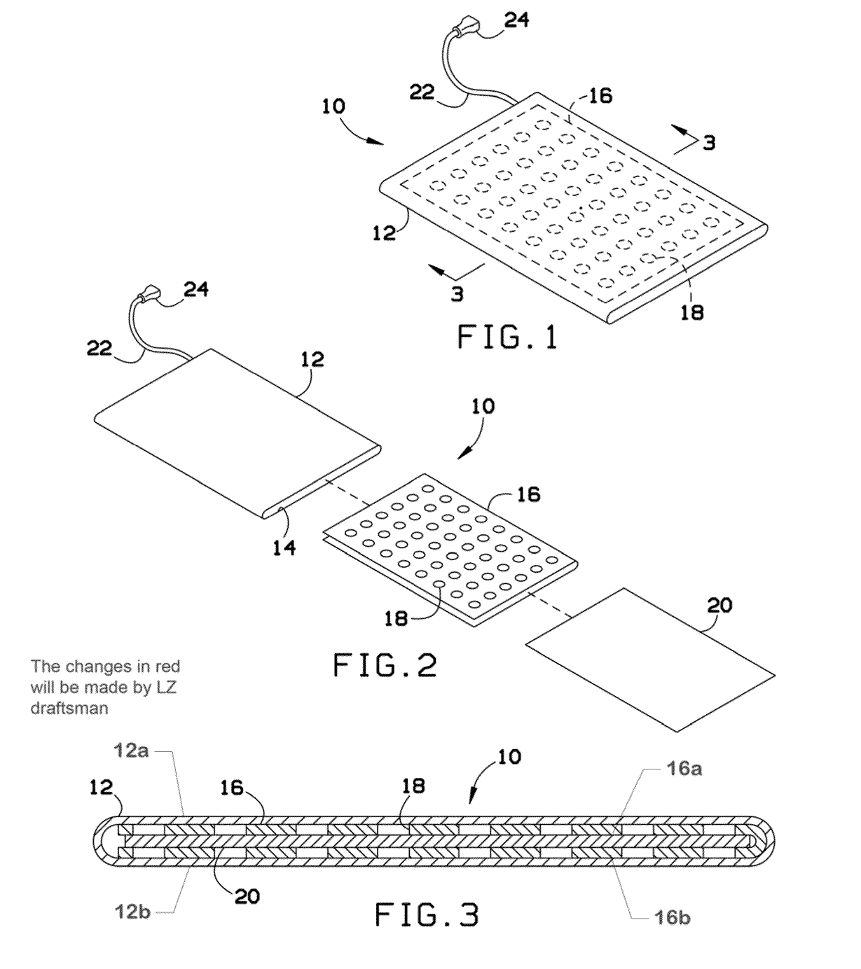

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a pressure contact switch that includes an outer contact sheet separated from an inner conductor by an insulator disposed therebetween. The insulator includes a plurality of apertures that allow electrical communication between the inner conductor and the outer contact sheet when a force is applied to the outer contact sheet, which is a conductive film.

Referring now to the Figures, a pressure switch 10 may include an outer contact tube 12, which may have an inner conductor 20 contained therein. Outer contact tube 12 may be separated from inner conductor 20 by an insulator 16, which may be an electrical insulator configured to have one or more insulator holes 18 formed therein. A cable 22 may be connected to inner conductor 20 and outer contact tube 12 by tape (not pictured) or a weld, for example, and may include a strain relief (not pictured). The tape may include a conductive tape or a foil, for example. Cable 22 may be a multiple-signal (composite) connector that may have a connector 24 on an end thereof, and may be configured to place inner conductor 20 and outer contact tube 12 in electrical communication with an electrical component to transmit a state (e.g., closed, open) of pressure switch 10 thereto.

According to one exemplary embodiment, cable 22 may be a single signal cable that may be connected to one of inner conductor 20 and outer contact tube 12, and the other one of inner conductor 20 or outer contact tube 12 may be directly assembled to, or in electrical communication with the electrical component, which may receive the state of pressure switch 10.

Referring now to FIG. 3, pressure switch 10 may be configured as a flat device wherein surfaces of contact tube 12, insulator 16, and inner conductor 20 may be oriented as a series of parallel sheets that may include a first planar contact sheet 12a, a second planar contact sheet 12b, a first planar insulator sheet 16a, and a second planar insulator sheet 16b. First planar contact sheet 12a may be joined to second planar contact sheet 12b along one or more edges thereof by heat seal or stitching, for example. First planar insulator sheet 16a may be joined to second planar insulator sheet 16b along one or more edges thereof by heat seal or stitching.

Pressure switch 10 may be in an open position when contact tube 12 is not in electrical contact or communication with inner conductor 20, and pressure switch 10 may be in a closed position when contact tube 12 is in electrical contact or communication with inner conductor 20. Insulator 16 may be a cloth or foam tube or sheet that may have holes 18 placed and sized such that a pressure or force applied to outer contact tube 12 may cause contact tube 12 or insulator 16 to sufficiently deflect, allowing electrical contact or communication between outer contact tube 12 and inner conductor 20 (e.g., pressure switch 10 in a closed position). Insulator 16 and outer contact tube 12 may be sufficiently elastic such that removal or absence of the pressure or force on outer contact tube 12 may cause pressure switch 10 to return or remain in an open position. It will be appreciated that pressure switch 10 is a normally open switch.

According to some exemplary embodiments, outer contact tube 12 may be formed as a cylinder that defines an inside space that may be configured to contain insulator 16, which may also be formed as a cylinder configured to contain inner conductor 20. Outer contact tube 12 may have an opening 14 on an end thereof that may receive insulator 16 and inner conductor 20 therethrough. According to other exemplary embodiments, insulator 16 may include a planar insulator sheet that is doubled (e.g., folded) onto itself and configured to envelop inner conductor 20.

According to some exemplary embodiments, outer contact tube 12 may be a conductive film such as carbon impregnated polyolefin. Inner conductor 20 may be a conducting surface, metal, or film (e.g., carbon impregnated polyolefin). Holes 18 may be die cut in insulator 16. Cable 22 may include a conductive wire, tape, or film, for example. According to another exemplary embodiment, a portion (e.g., planar section) of outer contact tube 12 may be a conductive film, and some portions of outer contact tube 12 may be a non-conductive film.

It should be understood, of course, that the foregoing relates to exemplary embodiments of the invention and that modifications may be made without departing from the spirit and scope of the invention as set forth in the following claims.

What is claimed is:

1. A pressure switch assembly, comprising:
an outer contact tube, wherein the outer contact tube comprises a first planar contact sheet and a second planar contact sheet, wherein the first contact sheet is parallel to the second contact sheet;
an inner conductor disposed between the first contact sheet and the second contact sheet; and
an insulator disposed between the outer contact tube and the inner conductor, wherein the insulator comprises a first planar insulator sheet, wherein the first insulator sheet is parallel to the first planar contact sheet, and wherein a force applied to the outer contact tube effects electrical contact between the outer contact tube and the inner conductor.

2. The pressure switch assembly of claim 1, wherein the insulator further comprises a second planar insulator sheet, wherein the first insulator sheet is disposed between the first contact sheet and the inner conductor, and wherein the second insulator sheet is disposed between the second contact sheet and the inner conductor.

3. The pressure switch assembly of claim 2, wherein the first contact sheet is bonded to the second contact sheet along a length of a perimeter of the first contact sheet, and wherein the first insulator sheet is bonded to the second insulator sheet along a first edge of the first insulator sheet.

4. The pressure switch assembly of claim 1, wherein the second contact sheet is a non-conductive film, wherein the first insulator sheet is disposed between the first contact sheet and the inner conductor.

5. The pressure switch assembly of claim 2, further comprising:
a cable in electrical communication with the inner conductor; and
a connector disposed on the cable.

6. The pressure switch assembly of claim 3, wherein the outer contact tube is a conductive film.

7. A pressure switch, comprising:
an outer contact sheet;
an inner conductor; and
an insulator disposed between the outer contact sheet and the inner conductor,
wherein the insulator has a plurality of apertures formed therein that allow electrical communication between the outer contact sheet and the inner conductor in response to a force applied to the outer contact sheet,
wherein the outer contact sheet is a conductive film.

8. The pressure switch of claim 7, wherein the conductive film is carbon impregnated polyolefin.

9. The pressure switch of claim 8, wherein:
the inner conductor is carbon impregnated polyolefin, and
the insulator is an insulator chosen from a group consisting of cloth and foam tube.

10. The pressure switch of claim 7, further comprising a wire disposed on the inner conductor.
